(19) United States
(12) Patent Application Publication
(10) Pub. No.: US 2008/0195447 A1
(43) Pub. Date: Aug. 14, 2008

(54) SYSTEM AND METHOD FOR CAPACITY SIZING FOR COMPUTER SYSTEMS

(76) Inventors: Eric Bouillet, Englewood, NJ (US); Zhen Liu, Tarrytown, NY (US); Dimitrios Pendarakis, Westport, CT (US); Li Zhang, Yorktown Heights, NY (US)

Correspondence Address: KEUSEY, TUTUNJIAN & BITETTO, P.C., 20 CROSSWAYS PARK NORTH, SUITE 210, WOODBURY, NY, 11797, US

(21) Appl. No.: 11/673,118

(22) Filed: Feb. 9, 2007

(51) Int. Cl. G05B 19/418; G06F 9/46

(52) U.S. Cl. 705/8

(57) ABSTRACT

A system and method for capacity sizing in a computer device or system includes determining one or more classes of operations based on at least one of historical computational usage and predicted usage for a system. Based on the one or more classes of operations, at least one capacity target is set based on the computational usage for each class such that computational capacity is maintained at a set level over a given time period and the set level satisfies at least one usage criterion over the given time period.

### BACKGROUND

1. Technical Field

The present invention relates to efficient computer capacity control and more particularly to systems and methods for sizing computer systems, which include a plurality of procedures that determine capacity sizes based on user performance requirements for batch, transactional and other applications.

2. Description of the Related Art

E-business hosting centers often include hundreds or thousands of computer systems. Management of amounts of resources allocated to these large numbers of systems is a challenging task. One particularly important problem is capacity sizing which is needed to determine the appropriate capacity size allocations for each server. It would be beneficial to determine the appropriate capacity sizes so as to guarantee that the server capacity is sufficient to handle an arrival load (requests, transactions, etc.) within prescribed user/customers performance requirements.

The capacity problem is particularly important for systems with resource virtualization capacities, such as IBM®'s mainframe computers, p-Series with POWERS™ technology and x-Series with virtualized infrastructure such as VMware™ or Hypervisor™. These systems permit the logical partitioning of physical hardware system resources, such as processors and memory, into fractional units, thereby permitting more flexible and more accurate allocation of system resources to individual customers and/or applications.

Existing capacity sizing algorithms are mostly ad-hoc methods based on statistical parameters such as the observed peak or a percentile of the system utilization data. Such algorithms are very sensitive to noise or other sources of jitter in the system measurements. These algorithms often over-estimate the capacity requirement and lead to waste of system resources.

### SUMMARY

A system and method for capacity sizing in a computer device or system includes determining one or more classes of operations based on at least one of historical computational usage and predicted usage for a system, Based on the one or more classes of operations, at least one capacity target is set based on the computational usage for each class such that computational capacity is maintained at a set level over a given time period and the set level satisfies at least one usage criterion over the given time period.

In alternate embodiments, the one or more classes includes a batch class and at least one capacity target includes a capacity, m, set to indicate an amount of work that can be completed in a given time period. The capacity, m may include determining residual work above the capacity and queuing the residual work in a next time period. The at least one usage criterion may include an amount of residual work, and the method may include limiting the residual work such that the residual work can be completed in a defined period after a period where the residual work has occurred. The capacity, m, may be manually set to guarantee a level of performance.

In other embodiments, the one or more classes may include a transactional class and at least one capacity target may be set to provide less than a maximum amount of lost work in a given time period. This may include determining lost work by computing a utilization area under a utilization curve above a set capacity. The at least one usage criterion may include a maximum percentage of lost work, and the method may include limiting the utilization area to an amount corresponding to less than the maximum percentage of lost work. The capacity, m, may be manually set to guarantee a level of performance.

The methods further include optimizing the computational capacity based on the at least one target objective using a binary search method.

Another method for capacity sizing in a computer device or system includes determining one or more classes of operations based on at least one of historical computational usage and predicted usage for a system. For batch processing, the method includes setting a first capacity target to indicate an amount of work capacity that can be completed in a given time period; and determining residual work above the first capacity target while meeting a first usage criteria such that queuing the residual work in a next time period maintains usage at the first capacity target. For transactional processing, the method includes setting a second capacity target that provides less than a maximum amount of lost work in a given time period by computing a utilization area under a utilization curve above the second capacity target.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block/flow diagram showing a system/method for sizing capacity in a computer system in accordance with one embodiment;

FIG. 2 is a bar chart showing an observed/measured/predicted computational load as a reference for batch tasks;

FIG. 3 is a bar chart for batch tasks showing a computational load with a sizing capacity of 80% in accordance with an illustrative embodiment;

FIG. 4 is a bar chart for batch tasks showing a computational load with a sizing capacity of 70% in accordance with another illustrative embodiment;

FIG. 5 is a chart showing a computational load for transactional tasks over time and showing a utilization area exceeding a capacity in accordance with an illustrative embodiment; and

FIG. 6 is a block/flow diagram showing a system/method for sizing capacity in a computer system in accordance with another embodiment.

### DETAILED DESCRIPTION OF PREFERRED EMBODIMENTS

Embodiments in accordance with present principles provide for sizing computer systems. In particularly useful embodiments, a plurality of procedures are employed to determine the capacity sizes based on user performance requirements for different applications, e.g., batch applications, transactional applications, combinations of these, etc. Present embodiments consider, as input, past observed system utilization data as measured on a current resource allocation or predicted utilization data based on estimates or models. This data may be suboptimal, but still useful for determining future utilization information and provide an initial capacity guess. Observed systems exhibit different types of behavior depending on whether the applications are of, e.g., batch or transactional nature. The difference between these two types of applications is mainly due to how they can respond to conditions during which the allocated resources are fully utilized. Embodiments will illustratively be described in terms of batch and transactional processes; however, other types of tasks may also be employed using similar methods.

For batch applications, the excess or unfinished work in a time interval can be queued and carried over to be processed in the next time interval. User provided performance requirements for batch applications can specify the maximum amount of extra time the busy period can last. For example, the requirement of an extra busy time of one time period implies that a capacity m is sufficient if, whenever the arriving workload is more than m, then all the residual work will be finished in the next time period.

For transactional applications, it is assumed that the arriving work is time sensitive, so any unfinished work during a time interval of full resource utilization is deemed lost. The user specified performance requirements for the transactional applications can be described as the maximum percentage of lost work over all time windows of a given length. For example, a requirement of maximum lost work percentage of 0.1% over a time window, e.g., size x, implies that a capacity m is sufficient if, the percentage of lost work is smaller than 0.1% for every time window of length x.

In accordance with the present embodiments, the systems and methods described herein provide many advantages in evaluating and capacity sizing computer Systems. For example, the embodiments include parameters that can provide level of performance guarantees. The embodiments can effectively filter outliers and/or noise in measurement data. For example, an isolated spike in a past utilization observation will have limited effect on the sizing decisions. The embodiments are efficient in running time as well, and can account for a wide range of different application classes. The type of application can be explicitly provided by the user/customer or inferred indirectly by observation of system parameters.

Embodiments of the present invention can take the form of an entirely hardware embodiment, an entirely software embodiment or an embodiment including both hardware and software elements. In a preferred embodiment, the present invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that may include, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

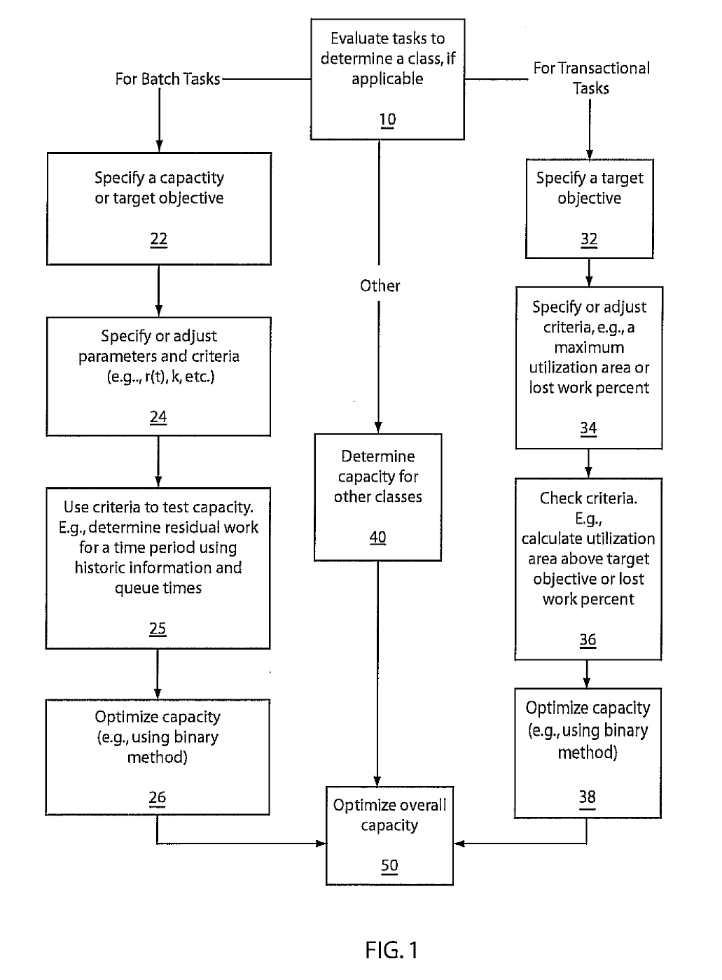

Referring now to the drawings in which like numerals represent the same or similar elements and initially to FIG. 1, a block/flow diagram is illustratively depicted for a sizing computer system. In block 10, a computer system's work tasks are evaluated to determine whether the tasks can be classed, e.g., as batch tasks, transactional tasks, combinations thereof or other tasks. If the tasks are batch tasks, then it is assumed that the workload tasks can be queued if there is not enough capacity to finish the incoming work in a given period or cycle. This may be determined based upon historic data or predicted behavior. In block 22, a capacity (m) or target objective is specified. This may include a user-specified value (e.g., an initial guess) or a dynamically determined value based on operating conditions or present environmental or system conditions.

For a specified capacity, m, the workload w(t) at time t may include residual (or remaining) work r(t) at time t. This may be expressed mathematically as:

w(t)=max(w(t−1)+r(t)−m,0) (1).

Equation (1) includes that w(t) equals the workload from a previous period w(t−1) plus the residual workload r(t) of this time period minus the base load or capacity load m. w(t) represents the maximum of (w(t−1)+r(t)−m) or zero. As mentioned, m may initially be user set or system determined.

In block 25, based on the historic or predicted information collected, check the target capacity against criteria. For example, the residual work is determined for a given time period based upon an initial guess or the target objective capacity. Capacity m is determined to be sufficient if a set criterion is met. In one embodiment, m is sufficient if, whenever the arrival work is more than m, then all the residual work will be finished in the next time period (or in the next k time periods, depending on the user setting). The parameters may be user determined and adjusted. For example, in block 24, a maximum permitted residual (r(t)) may be specified as a criterion to batch processing. In another embodiment, the residual can be defined as anything above the current capacity setting (m) that can be completed in a predefined time. The predefined time may include one or more cycles or periods. k may also be specified or changed.

A smallest sufficient capacity m is preferable to conserve resources. Therefore, m may be determined using a method to find an optimal CPU usage. For illustration purposes, assume size capacity is determined based on residual work being performed in a next time period. The size capacity (m) is adjusted according to the ability to perform all the tasks in a given time period in the next time period.

In block 26, to find a better capacity, the method may employ a binary search to determine the appropriate size capacity. Using the target capacity guessed or computed in block 22, a test of whether the excess or unfinished work (r(t)) in one time interval can be queued and carried over to be processed in the next time interval is performed. If this residual work can be completed, an optimal solution may have been determined (e.g., the initial guess was correct). However, if the residual was too high (could not complete the work in the next cycle or period) or too low (the actual processing percent was below the target capacity), an adjustment to the capacity may be needed. From the initial guess for capacity, say e.g., 80% usage, the usage is split in half to 40% usage in accordance with the binary search method. 40% usage is then checked against the criteria (e.g., will the residual work be handled in the next period). Next, the midpoint between 40% and 80% (or 60%) is checked to further improve the result. If better results are achieved by a larger usage than the midpoint between 60% and 80% is (70%) checked. This continues until the best capacity can be determined. Binary search methods are known in the art. Other methods may also be employed to optimize the results.

The user may provide a factor of safety or make special adjustments based upon known anomalies in the system. For example, if the system usage is high on New Year's Eve at midnight, etc. Performance requirements for batch applications can specify the maximum amount of extra time the busy period can last before additional capacity is needed and added. Other criteria for determining when and how work will be queued are also contemplated.

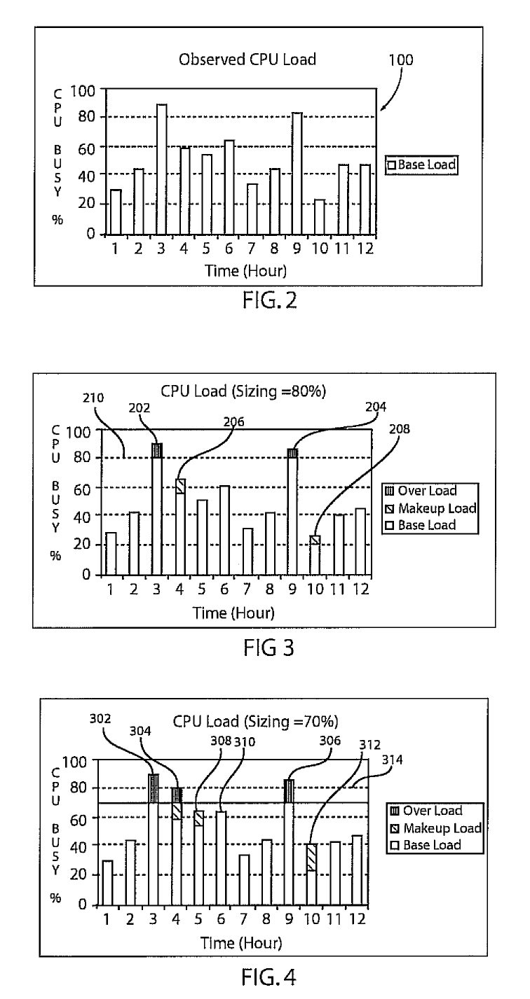

Referring to FIG. 2, a bar chart 100 illustratively shows an observed (historic data) computer processing load (CPU percent busy on the y-axis) for a computer system over a time period of 12 hours (x-axis). This data may also be predicted data, which represents a designer's estimate of a given computer usage load. Each period is one hour in this example although periods may be of any duration. FIG. 2 is employed to provide a historical basis for adjusting size capacity. It may be desirable to limit the percent busy to less than 100% as shown for FIGS. 3 and 4.

Referring to FIG. 3, based upon a sizing (target or initial guess) of 80% or sufficiency m being 80% of the computer system capacity, overloads 202 and 204 occur at hour 3 and hour 9. The overload 202 at hour 3 in accordance with the present principles may be queued for processing in hour 4 which has the capacity to handle this load as a makeup load 206 in hour 4. The overload 204 at hour 9 in accordance with the present principles may be queued for processing in hour 10 which has the capacity to handle this load as a makeup load 208 in hour 10. The selection of sizing of 80% was the initial guess as described above, however the capacity may be determined using a binary search method to determine an optimal sizing position 210 or the sizing may be user selected.

As described above, the 80% usage meets the criteria (e.g., residual work performed in a next cycle); however, this capacity may not be optimal. Hence, a binary search may be employed to optimize the capacity.

Referring to FIG. 4, after performing the binary search an optimal setting (70%) for capacity has been determined. Based upon a capacity m being 70% of the computer system capacity, overloads 302, 304 and 306 occur at hour 3, hour 4 and hour 9. The overload 302 at hour 3 in accordance with the present principles may be queued for processing in hour 4 which has the capacity to handle a portion of this load as a makeup load 308 in hour 4. The overload 306 at hour 4 (above the 70% mark 314) in accordance with the present principles may be queued for processing in hour 5 which has the capacity to handle this load as a makeup load 312 in hour 5. The overload 306 at hour 9 in accordance with the present principles may be queued for processing in hour 10 which has the capacity to handle this load as a makeup load 312 in hour 10. The selection of sizing of 70% was determined in this case to be optimal using the binary search method to determine the optimal sizing position 314.

FIGS. 3 and 4, employ the (past) observed system utilization data as measured on the current resource allocation to make a determination of current or further resource usage such that allocated resources are fully utilized in accordance with an optimal sizing capacity which carries out the batch processing such that the overflow or over load in a given time period can be queued and completed in the next time period. Other criteria are also contemplated.

Referring again to FIG. 1, if the work tasks are transactional, in block 32, a target objective or initial guess is set. For example, the target objective may be expressed so as to maintain CPU utilization percent less than the target. This may be user set or system determined. For transactional applications, it is assumed that the arriving work is time sensitive, so any unfinished work during a time interval of a full resource utilization would be deemed lost. In block 34, user specified criteria may be set. For example, the user specified performance requirements for the transactional applications can be described as a maximum percentage of lost work over all time windows of a given length. For example, a requirement of maximum lost work percentage of 0.1% over a time window size x, implies that a capacity m is sufficient if, the percentage of lost work is smaller than 0.1% for every time window of length x.

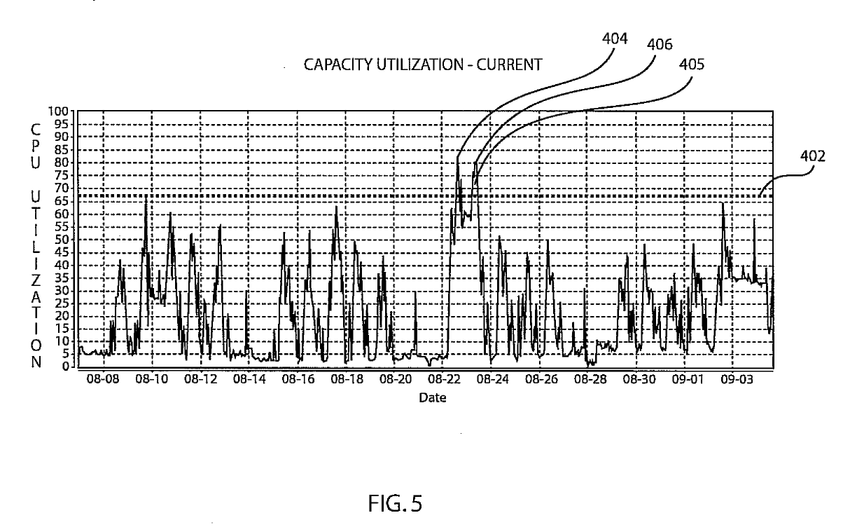

In addition, a maximum permitted utilization area that is permitted to exceed the target objective may also be provided in block 34. This may also be user set or system determined. The utilization area considers not only the percentage of samples above the target but also the area exceeding the target. Larger longer “spikes” impact sizing more than smaller shorter duration spikes even though the shorter duration spikes may have a larger peak magnitude. (See FIG. 5).

In block 36, the criterion/criteria are checked. For example, lost work is determined, or a percent area exceeding the utilization area is computed for any usage that exceeds the target objective based on the historical (or predicted) data and the initial guess. If the criteria are met, for example, the utilization area is less than the maximum allowed and/or the lost work is below the threshold set, then the capacity is sufficient. In block 38, a method is employed to find an optimal CPU usage. In one embodiment, the method includes a binary search method. The binary method may be applied as described above, taking the midpoint between the initial guess and A the initial guess and then taking the midpoint on the next segment to converge on an optimal capacity.

Block 40 provides for other classes of work tasks, e.g., hybrid combinations of batch and transactional tasks, long running tasks, constant tasks, etc. These tasks may have other sets of criteria for optimizing capacity.

Hybrids combination may be handled in different ways. For example: A) Fixed capacity assignment for batch and transactional workloads. This means the assignment does not change over time. This is a somewhat easy case. The problem can be decomposed into batch and transactional processes, and the problem for batch and transactional workloads can be handled separately. Then, the solutions can be combined. B) Variable capacity assignment. This means the capacity assigned to the two workloads can be different at different times. For this case, the capacity assignment is determined for each time segment. This problem can be formulated as a linear program.

In block 50, the capacity is set for further system processing. This capacity may be an overall system capacity based on the capacities optimized for one or more of the batch tasks, transactional tasks or other tasks. The overall capacity may be based on a combination of the optimized capacities or the overall capacity may consider all tasks at once.

Referring to FIG. 5, a target objective 402 is set for CPU utilization for transactional tasks. Upon exceeding this target objective, e.g., at points 404 and 406, a determination of the area under curve 405 above the target objective line is made. This area is compared to the utilization target and an optimal CPU percentage is determined (e.g., using the binary search method) to make up for these overloads. In other words, at times when CPU usage is above the target objective, the capacity may be shifted to provide optimized capacity.

The present principles provide parameters that can guarantee a certain level of performance. For example, by setting m, a performance level may be specified in terms of CPU usage. The present principles effectively filter outliers and/or noise in the measurement data. For example, an isolated spike in past utilization observations will have limited effect on the sizing decisions, which is preferable to capacity planners. The methods are efficient in running time as well, e.g., the complexity is O(data_length*ABS(log(accuracy))), where data_length is the number of input data points and accuracy is the acceptable error, for example, within 0.1 percent for CPU utilization. Since accuracy is smaller than 1, log(accuracy) is negative and the absolute value of log(accuracy) is used.

The algorithms can account for a wide range of different application classes and may be able to handle combinations of classes. For example, transactional and batch processes can be handled simultaneously. The type of application can be explicitly provided by the user/customer or inferred indirectly by observation of system parameters.

It should be understood that the present principles are applicable to a single computer, a single processor, a system of computers, a system of processors, a distributed network of computers, etc. The percent usage may include an overall system usage or the usage of a single CPU. In a system, overload computational tasks may be assigned to the same CPU or another CPU within the system. A CPU may be partitioned, and portions may be used to determine capacity, or portions may be included to provide additional capacity.

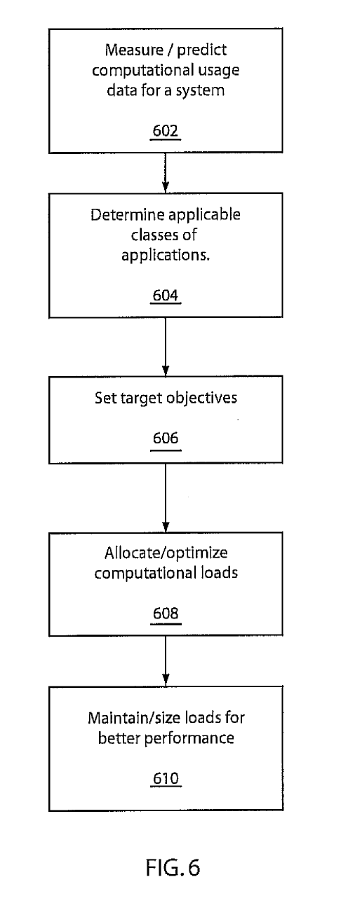

Referring to FIG. 6, a block/flow diagram illustratively shows one implementation in accordance with the present principles. In block 602, a CPU or a model is observed over a period of time to measure/predict computational usage data, e.g., as in FIG. 3. In block 604, a determination of one or more classes of computation types or applications is made. For example, batch, transactional, etc. or combinations thereof. This determination may be made based on actual computation types or based upon a historic view of computational operations. In block 606, target objectives are set, either automatically or manually. Target objectives may include capacity (m) in terms of computational percentages and/or allowable utilization area, as illustratively described above.

In block 608, computational loads are allocated and/or optimized to time periods based upon the historic observed or predicted loads. A binary search method or other method may be employed to optimize the CPU usage in block 610, CPU loads are sized and maintained as a result of the allocation for better performance.

Having described preferred embodiments of a system and method for capacity sizing for computer systems (which are intended to be illustrative and not limiting), it is noted that modifications and variations can be made by persons skilled in the art in light of the above teachings. It is therefore to be understood that changes may be made in the particular embodiments disclosed which are within the scope and spirit of the invention as outlined by the appended claims. Having thus described aspects of the invention, with the details and particularity required by the patent laws, what is claimed and desired protected by Letters Patent is set forth in the appended claims.

What is claimed is:

1. A method for capacity sizing in a computer device or system, comprising:
determining one or more classes of operations based on at least one of historical computational usage and predicted usage for a system;
based on the one or more classes of operations, setting at least one capacity target based on the computational usage for each class such that computational capacity is maintained at a set level over a given time period and the set level satisfies at least one usage criterion over the given time period.

2. The method as recited in claim 1, wherein the one or more classes includes a batch class and setting at least one capacity target includes setting a capacity, m, to indicate an amount of work that can be completed in a given time period.

3. The method as recited in claim 2, wherein setting the capacity, m, includes determining residual work above the capacity and queuing the residual work in a next time period.

4. The method as recited in claim 2, wherein the at least one usage criterion includes an amount of residual work, and the method includes limiting the residual work such that the residual work can be completed in a defined period after a period where the residual work has occurred.

5. The method as recited in claim 2, wherein setting the capacity, m, includes manually setting the capacity to guarantee a level of performance.

6. The method as recited in claim 1, wherein the one or more classes includes a transactional class and setting at least one capacity target includes setting a capacity, m, to provide less than a maximum amount of lost work in a given time period.

7. The method as recited in claim 6, wherein setting the capacity, m, includes determining lost work by computing a utilization area under a utilization curve above a set capacity.

8. The method as recited in claim 7, wherein the at least one usage criterion includes a maximum percentage of lost work, and the method includes limiting the utilization area to an amount corresponding to less than the maximum percentage of lost work.

9. The method as recited in claim 6, wherein setting the capacity, m, includes manually setting the capacity to guarantee a level of performance.

10. The method as recited in claim 1, further comprising optimizing the computational capacity based on the at least one target objective using a binary search method.

11. A computer program product for capacity sizing a computer device or system comprising a computer useable medium including a computer readable program, wherein the computer readable program when executed on a computer causes the computer to perform the steps of:
determining one or more classes of operations based on at least one of historical computational usage and predicted usage for a system;
based on the one or more classes of operations, setting at least one capacity target based on the computational usage for each class such that computational capacity is maintained at a set level over a given time period and the set level satisfies at least one usage criterion over the given time period.

12. The computer program product as recited in claim 11, wherein the one or more classes includes a batch class and setting at least one capacity target includes setting a capacity, m, to indicate an amount of work that can be completed in a given time period.

13. The computer program product as recited in claim 12, wherein setting the capacity, m, includes determining residual work above the capacity and queuing the residual work in a next time period.

14. The computer program product as recited in claim 11, wherein the one or more classes includes a transactional class and setting at least one capacity target includes setting a capacity, m, to provide less than a maximum amount of lost work in a given time period.

15. The computer program product as recited in claim 14, wherein setting the capacity, m, includes determining lost work by computing a utilization area under a utilization curve above the capacity.

16. The computer program product as recited in claim 11, further comprising optimizing the computational capacity based on the at least one target objective using a binary search method.

17. A method for capacity sizing in a computer device or system, comprising:
determining one or more classes of operations based on at least one of historical computational usage and predicted usage for a system;
for batch processing, setting a first capacity target to indicate an amount of work capacity that can be completed in a given time period; determining residual work above the first capacity target while meeting a first usage criteria such that queuing the residual work in a next time period maintains usage at the first capacity target; and
for transactional processing, setting a second capacity target that provides less than a maximum amount of lost work in a given time period by computing a utilization area under a utilization curve above the second capacity target.

18. The method as recited in claim 17, wherein setting the first capacity includes limiting residual work such that the residual work can be completed in a defined period after a period where the residual work has occurred.

19. The method as recited in claim 17, wherein setting the second capacity target includes limiting the utilization area to an amount corresponding to less than a maximum percentage of lost work.

20. The method as recited in claim 17, further comprising optimizing sizing capacity based on the first and second target objectives using a binary search method.
